(19) United States
(12) Patent Application Publication
(10) Pub. No.: US 2001/0024189 A1
(43) Pub. Date: Sep. 27, 2001

(54) Merchant-specific computer peripheral device and method of promoting business

(76) Inventor: David Michie, Maple Glen, PA (US)

Correspondence Address: Esther H. Chong, Esquire, Synnestvedt & Lechner LLP, 2600 Aramark Tower, 1101 Market Street, Philadelphia, PA, 19107-2950, US

(21) Appl. No.: 09/742,026

(22) Filed: Dec. 21, 2000

Related U.S. Application Data
(60) Provisional application No. 60/171,411, filed on Dec. 21, 1999.

(51) Int. Cl. G09G 5/00

(52) U.S. Cl. 345/156

(57) ABSTRACT

A computer peripheral device, such as a mouse, and a method of promoting a merchant using the computer peripheral device. A marketing service is provided to a plurality of merchants who are interested in promoting business. The marketing service involves providing “merchant-specific” computer peripheral devices to preselected recipients or directly to the merchant. The devices are configured specifically for each merchant in that Website information associated with the merchant or a Website access triggering signal is programmed into the computer peripheral devices. The company logo, Web address or other merchant-specific information is also provided on a surface of the computer peripheral device. These merchant-specific devices are distributed to the preselected recipients, e.g., current or potential customers or vendors of the merchant. The recipients can access automatically one or more Websites of the merchant by merely actuating the Web switch on the device.

### RELATED APPLICATION

This patent application claims benefit of priority based on U.S. Provisional Patent Application No. 60/171,411 (Attorney Docket No. 03227-P0001A GSW/JBW) filed on Dec. 21, 1999, invented by Dave Michie, and entitled “Branded Computer Mouse,” which is herein fully incorporated by reference.

BACKGROUND OF THE INVENTION

1. Field of the Invention The invention pertains to business methods and computer peripheral devices. More particularly, the invention pertains to methods of promoting business of an online merchant using a merchant-specific computer peripheral device such as a computer mouse.

2. Discussion of the Related Art

As Internet technologies continue to develop and new online services become available, more users are accessing the Internet. Typically, if a user wishes to access a particular Website (or Web page) on the Internet, the user runs a piece of software known as a Web browser installed on his or her computer, which connects the computer to the Internet, e.g., through a modem. The user types in a Web address or an URL (Uniform Resource Locator) of the desired Website using the keyboard, or clicks on-screen icons provided by the Web browser to select one of the stored Website addresses. The Web browser processes the Website request (i.e., the URL request) and transmits it to an appropriate server (e.g., a proxy server or an application server) over the Internet. The server responds to the Website request and transmits to the Web browser a Web page (e.g., in HyperText Markup Language or HTML files) corresponding to the requested Website. The Web browser receives the Web page and displays it on the user's computer monitor, whereby the user accesses the desired Website.

The above-described conventional process of accessing a Website, however, is inconvenient to the user because the user must either type in the URL which often is lengthy and difficult to remember, or click on multiple icons to select one of the stored URLs. From the perspective of electronic business merchants (hereinafter “e-merchants”), the conventional process hinders potential customers from accessing the Websites of the e-merchants easily, which can result in a significant loss of profit for the e-merchants.

Thus, there is a need for a device and method which overcomes the problems involved with the conventional method of accessing Websites. Further, a need exists for a device and business method which encourages accessing of e-merchant Websites and conducting online transactions through those Websites.

Accordingly, it is an object of the present invention to provide a method of promoting e-business.

It is another object of the present invention to provide a computer peripheral device for promoting business of an e-merchant.

It is another object of the present invention to provide a method of tracking the accessing of a predetermined site/page of an e-merchant on a communications network using merchant-specific computer peripheral devices.

It is another object of the present invention to provide a computer mouse or other computer peripheral device having at least one pre-programmed switch for automatically accessing at least one predetermined site/page on a communications network.

It is a further object of the present invention to provide a business method and a computer peripheral device for improving customer relations and providing competitive business advantages to e-merchants or Website sponsors.

It is still another object of the present invention to provide a computer peripheral device which can be used both as an advertising tool and a market studying tool in electronic commerce.

### SUMMARY OF THE INVENTION

The present invention is directed to a computer peripheral device and a method of promoting e-merchants using the computer peripheral device, such as a computer mouse or keypad.

In accordance with the present invention, a marketing service is provided to a plurality of merchants who are interested in promoting their online businesses. The marketing service involves providing “merchant-specific” computer peripheral devices to preselected recipients or directly to the merchant. The devices are configured specifically for each merchant in that Website information associated with the merchant or a Website access triggering signal is programmed into the computer peripheral devices. The company logo, Web address or other merchant-specific information is also provided on a surface of the computer peripheral device. These merchant-specific devices are distributed to the preselected recipients, e.g., current or potential customers or vendors of the merchant.

As long as the peripheral device is located within the visual range of the recipient, the recipient will view the merchant information on the surface of the device and be constantly reminded of the merchant and/or the merchant's Website. Furthermore, once a recipient's computer is configured to accept commands from the peripheral device, the recipient can press at least one pre-configured switch (a Web switch) on the computer peripheral device and be connected automatically to a Website provided by the merchant. This Website may be the home page of the merchant or a Computer Peripheral Device (CPD) Website dedicated exclusively to the recipients of the merchant-specific peripheral devices that can function as a Web destination itself or as a redirect site for automatically redirecting the user to another Website (e.g., the home page of the merchant). In the latter embodiment, the user may be connected automatically to the CPD Website and then the main Website of the merchant by actuating the Web switch on the computer peripheral device. The CPD Website can also be used to track the timing and frequency of Website access using the Web switches of the merchant-specific computer peripheral devices. This tracking information can be used by the merchant or other interested parties in market studies or research to further improve business.

The Web switch provides a simple and convenient means to access the Website(s) of the merchant. The convenience of accessing the merchant's Website(s) using the Web switch encourages more frequent access of the e-merchant's Website(s) by the recipient. The operation of the Web switch is so simple in that anyone, including children and seniors, can now access easily the Website(s) of the merchant.

Other objects and advantages of the present invention will be set forth in part in the description and the drawings which follow, and, in part, will be obvious from the description or may be learned by practice of the invention.

### BRIEF DESCRIPTION OF THE DRAWINGS

FIG. 1 is a block diagram for explaining business methods of the present invention.

FIG. 2 is a pictorial representation of a computer mouse in accordance with the present invention.

FIG. 3 is a block diagram of the computer mouse shown in FIG. 2, coupled to a host computer, according to the present invention.

### DETAILED DESCRIPTION OF THE PREFERRED EMBODIMENTS

In the present specification, a merchant can be an e-merchant or any other sponsor of a Website such as ISPs, ASPs, etc. The terms “merchant” and “e-merchant” are also used herein interchangeably and are intended to include both for-profit and non-profit entities that maintain an Internet presence.

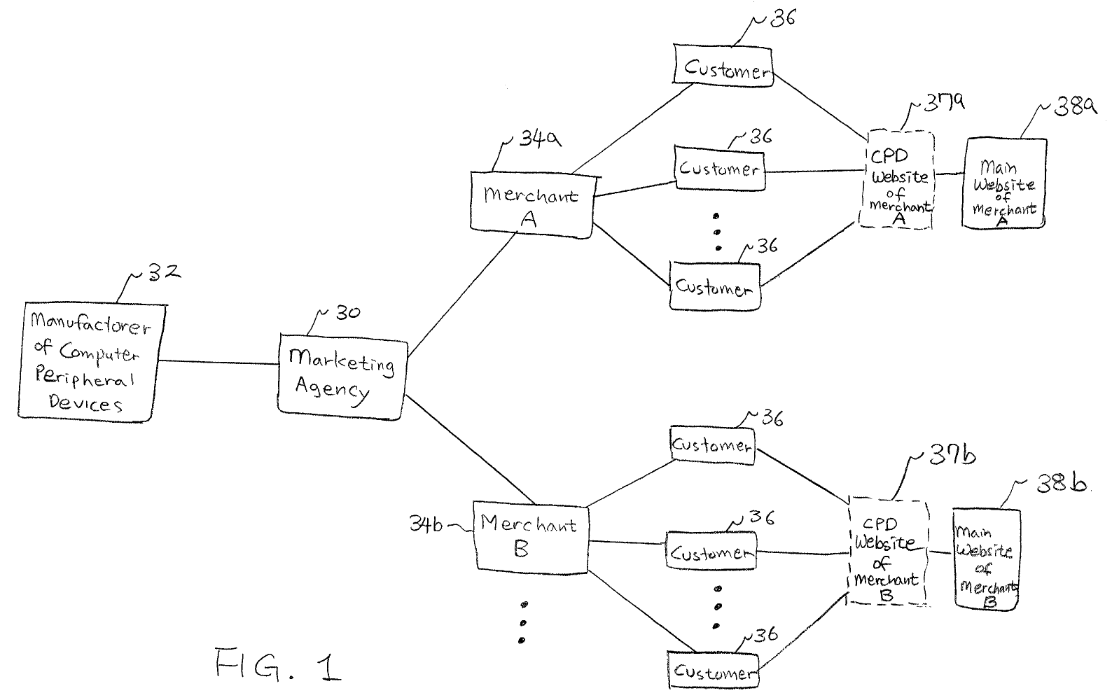

FIG. 1 shows a block diagram of an embodiment of the method of marketing a business in accordance with the present PATENT Docket No. P-24,581 USA invention. Referring to FIG. 1, a marketing agency 30 provides the unique marketing service of the present invention to a plurality of e-merchants 34a, 34b, etc. The marketing agency 30 may be any entity that provides this marketing service, e.g., RCG International Inc. located in Maple Glen, Pa. The e-merchants 34 may be e-business merchants having Websites (e.g., General Electric, Inc., E*trade Securities, Inc., Professional Golf Association, etc.) as well as any other entity that sponsors Websites, e.g., ISPs, ASPs, search engine providers, etc.

The marketing service of the present invention involves providing “merchant-specific” computer peripheral devices specifically manufactured for each e-merchant 34a, 34b. The computer peripheral devices are considered “merchant-specific” as: (1) each of the computer peripheral devices for a particular e-merchant is provided with merchant-specific information, e.g., a logo, a Website address or other merchant information associated with the particular e-merchant, and (2) each device includes at least one pre-programmed switch (Web switch) which, upon actuation by a user, automatically connects the user to at least one predetermined Website associated with the e-merchant.

In accordance with the present invention, the merchant-specific information provided on the computer peripheral devices for viewing by the users is not associated with a manufacturer of the computer peripheral devices. The merchant information may identify a sponsor of the predetermined Website accessible by the Web switch of the merchant-specific computer peripheral device, but it does not identify a maker or a manufacturer of the merchant-specific computer peripheral device.

In one embodiment, upon actuation of the pre-programmed switch, the user is first connected to a Computer Peripheral Device (CPD) Website, which automatically relays the user to another Website, such as the home page of the e-merchant. In this embodiment, the CPD Website can function as a tracking site, for tracking the timing and frequency of Website access by the users using the pre-programmed switches on the merchant-specific peripheral devices. The tracking information can be used in market studies and research to further improve the business of the e-merchant.

In another embodiment, the CPD Website may be used as a promotional page for displaying information tailored specifically for the merchant-specific peripheral device users, e.g., discounted products/services or other information associated with the e-merchant. In this case, the user may not be redirected automatically from the CPD Website to another Website of the e-merchant, but the user may access other e-merchant Websites if desired by performing a single act, e.g., clicking a designated icon on the CPD Website.

While a computer mouse is a preferred merchant-specific computer peripheral device of the present invention, other examples of other merchant-specific computer peripheral devices include, but are not limited to, keypads, styluses, or any other computer peripheral devices.

A method of promoting business is now described according to one embodiment of the present invention. The marketing agency 30 enters into an agreement with each e-merchant 34a, 34b who is interested in receiving the marketing service offered by the marketing agency 30. In accordance with the agreement, the marketing agency 30 instructs a manufacturer 32 to produce merchant-specific computer peripheral devices (e.g., computer mice) configured specifically for the e-merchant 34a, 34b. For example, if an e-merchant 34a such as General Electric, Inc. (GE) agrees to receive the marketing service of the marketing agency 30, the marketing agency 30 instructs the manufacturer 32 to produce computer peripheral devices, such as computer mice, wherein each mouse has at least one predetermined Web address (e.g., “GE.COM” or “GEmouse.COM”) associated with GE or GE logo provided thereon, and at least one pre-programmed switch for accessing automatically one or more Websites associated with GE.

In one embodiment, computer software for selectively activating the pre-programmed switch of the merchant-specific device may also be produced for use with the merchant-specific device, wherein the software is to be installed into a user's computer. In other embodiments, the computer peripheral device itself may be pre-loaded with software and/or data for instructing the user's computer to access automatically one or more Websites of the designated merchant. This software may also be designed to upload automatically from the computer peripheral device to the user's computer when the computer peripheral device is initially set up and connected to the user's computer. In this embodiment, the user need not install separate software into the computer.

The marketing agency 30 then delivers the merchant-specific computer peripheral devices (and the computer software if applicable) to the appropriate e-merchant 34a, 34b. The e-merchant 34a, 34b or any entity designated by the e-merchant 34a, 34b distributes these computer-peripheral devices to preselected recipients, e.g., current or potential customers 36, e.g., either at no cost or for a fee. Each customer 36 installs the merchant-specific computer peripheral device (and the merchant-specific computer software, if applicable) on his or her personal computer (PC). As long as the computer peripheral device is located within the visual range of the customer 36, the customer 36 will view the e-merchant information (e.g., GE.COM, GEmouse.COM, GE, etc.) provided on the surface of the peripheral device and be constantly reminded of the e-merchant and/or e-merchant Website(s). The e-merchant information provided on the computer peripheral devices for viewing by the customer 36 is not associated with a manufacturer of the computer peripheral device.

When the customer 36 actuates the pre-programmed Website switch on the computer peripheral device (assuming that the computer is loaded with an appropriate browser, is connected to the Internet and is turned on), a triggering signal or a prestored Web address of a CPD Website 37a is transmitted from the peripheral device to the PC. Where the PC receives the triggering signal, it responds to the triggering signal by retrieving the prestored Web address of the CPD Website 37a from its memory, and processes it as a Web site request according to known techniques. Where the PC receives the Web address of the CPD Website 37a from the peripheral device, it processes it as a Web site request according to the known techniques.

In one embodiment, the CPD Website 37a may function solely as a tracking site for the main Website 38a of the e-merchant, for maintaining data indicating the access frequency and times at which the main Website 38a is accessed using the merchant-specific peripheral devices. Thus, in response to the Website request, a server associated with the CPD Website 37a may return a “redirect” page to the customer's PC while it redirects the customer 36 to the page of the main Website 38a and increases the access count. The page (e.g., Home Page) of the main Website 38a of the merchant 34a will be displayed on the PC. A redirect page may provide a notice to the customer 36 that he or she is being redirected to the main Website 38a. It may also provide merchant-specific information, e.g., advertising or company information, which can be viewed for a short time period during which the redirect page is displayed to the customer 36.

In accordance with another embodiment, the CPD Website 37a can function as a promotional site for the merchant 38a for displaying ads, sales, and other information, and the system may not redirect the customer 36 automatically from the CPD Website 37a to another Website 38a. This will give the customer 36 an opportunity to view the information provided by the CPD Website 37a and select hyperlinks displayed thereon. Promotional schemes for promoting the use of the computer peripheral devices can be incorporated into this embodiment. For instance, the merchant 36a may select (randomly or according to some predetermined criteria) a prize winner from the customers who access the CPD Website 37a using the computer peripheral devices. The announcement whether the current customer 36 is a winner may be displayed on the page of the CPD Website 37a immediately after the customer 36 actuates the Website switch on the peripheral device or may be delivered via other means, e.g., email. The server associated with the CPD Website 37a may also keep a count of number of times the CPD Website 37a was accessed by customers using the peripheral devices of the present invention. If desired, an icon button may be provided on the page of the CPD Website 37a which, upon clicking, connects the customer 36 automatically to the page of the main Website 38a.

Therefore, the business methods of the present invention provide an effective and powerful way for e-merchants to promote themselves to individuals through the merchant-specific computer peripheral devices. Furthermore, the merchant-specific computer peripheral devices allow a particular e-merchant to be distinguished over all other e-merchants due to (1) the e-merchant information provided on the devices and (2) the direct Website accessibility enabled by the pre-programmed switch. Moreover, Website tracking information obtained through the CPD Website can be used in market studies and research so that the business and visibility of the e-merchant can be further improved.

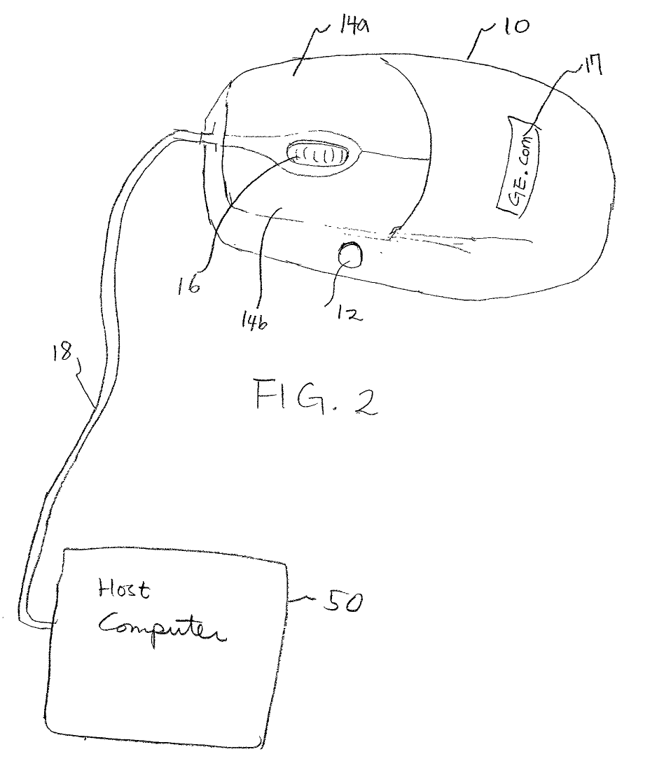

FIG. 2 shows a pictorial representation of a computer mouse according to a preferred embodiment of the present invention. The computer mouse of FIG. 2 is an example of a merchant-specific computer peripheral device which can be used to promote e-business as discussed hereinabove referring to FIG. 1. It should be clearly understood that the present invention is not limited to the particular design, shape, size or configuration of the mouse shown in FIG. 2, but includes any variations thereof.

As shown in FIG. 2, the computer mouse 10 of the present invention includes a pre-programmed Web switch 12, “right” and “left” switches 14a and 14b, a scroller 16 (optional), a mouse ball (not specifically shown) located underneath the mouse 10 for moving a cursor, and a connector 18 for connecting to a host computer 50 such as a desktop, a laptop, etc. The host computer 50 is set up with appropriate applications, such as the Web browser, user interface programs, operating systems, etc., for operating the computer and connecting to and accessing the Internet or other communications networks, e.g., intranets.

The Web switch 12 encompasses an actuating surface (e.g., a button) as well as any circuitry associated with it. The Web switch 12 is “pre-programmed” with Website data that allows the user to access automatically at least one designated Website of a merchant (e.g., CPD Website 37a, or CPD Website 37a and main Website 38a) by actuating the Web switch 12. That is, the Web switch 12 is fixedly configured to transmit pre-stored Website data when it is actuated. If needed, a small memory such as RAM may be provided in the mouse 10 to store the Website data. The pre-programming of the Website data in the mouse 10 is permanent and may not be altered or reprogrammed by the user.

In one embodiment, the Website data may include a Web address or URL of the designated Website, e.g., CPD Website of a merchant. In addition, the Website data may include user's personal data (e.g., user's account information, user's PIN, shipping address, etc.) which may be associated with accessing the CPD Website or the main Website of a merchant. In this embodiment, when the user actuates the Web switch 12, the URL of the designated Website and the user's personal data may be transmitted to the host computer 50. The host computer 50 processes the URL as if the user had entered the URL in the Web browser user interface and transmits it to an appropriate server through the Internet or other networks. The manner in which the host computer 50 processes and transmits the Web address such as the URL is well known in the art and will not be discussed in detail. The host computer 50 may also transmit the user's personal data received from the computer mouse 10 to the server, if appropriate. For example, in some applications, the server may need the user's personal data (e.g., user's PIN or password) before it allows the user to access the designated Website. In other applications, the user's personal data (e.g., shipping address) may be used by the server as a substitute to the user's manual input.

In another embodiment, the Website data pre-programmed in the mouse 10 may be triggering data (e.g., a fixed signal), so that when the host computer 50 receives this data, it automatically retrieves a particular, pre-stored URL (e.g., URL of the CPD Website 37a of the merchant) from its memory and processes it as discussed above.

The pre-programmed Web switch 12 (i.e., the actuating surface area thereof) can be configured to emit light (e.g., using an LED) to attract the user's attention and/or to indicate the operational status of the Web switch 12. Various examples for implementing such features are possible. For instance, the Web switch 12 can emit light continuously or, alternatively, until the user actuates the Web switch 12, at which time, it may emit the light at a different emission frequency (e.g., the light may flicker). Different light colors (e.g., green to red) may be used to indicate the operational status of the Web switch 12. In the alternative, the Web switch 12 may be illuminated only after the user actuates or presses the Web switch 12.

The mouse ball located underneath the mouse 10, if the mouse 10 is of such type, allows the user to maneuver the cursor on the computer monitor by moving or rolling the ball on a surface. The “right” and “left” switches 14a and 14b are typically used to select items displayed on the monitor using the cursor. The scroller 16, which is optional, is used to scroll down or up a page displayed on the monitor. The operations of these switches 14a, 14b, the scroller 16 and the mouse ball are well known in the art, e.g., see U.S. Pat. No. 5,530,455 to Gillick et al. which discloses a computer having such features. The disclosure of U.S. Pat. No. 5,530,455 is herein fully incorporated by reference.

In accordance with the present invention, the computer mouse 10 further includes an area 17 for displaying certain text and/or an image(s) associated with a merchant or a predetermined Website of the merchant accessible by actuating the switch 12. The area 17 can comprise a portion of the surface of the mouse 10 as shown in FIG. 2, but is not limited to such and can cover portions of any surface of the mouse 10 or the entire surface of the mouse 10. The area 17 can be used as a display for advertising the Website information or the Website sponsor information, e.g., merchant information. The company logo, name, brand, Web address or any other information may be displayed on the area 17 so that the user can be aware of the Website or the sponsor thereof, linked to the Web switch 12. In one instance, the advertising information can be printed on the area 17. In other instances, the area 17 can be an LCD or other electronic/optical display for displaying the advertising information.

In addition, the mouse 10 can be configured to illuminate the area 17 when it is connected to the host computer 50. This may be accomplished under control of a processor/interface in the mouse 10. For example, the processor/interface can control the illumination of a light source in the area 17 when the processor/interface detects a connection between the mouse 10 and the computer 50.

In accordance with other embodiments, the computer mouse 10 may include a plurality of pre-programmed Web switches 12 such that multiple pre-designated Websites of a single e-merchant or multiple e-merchants may be selectively and directly accessed by the operation of these Web switches.

One skilled in the art would readily understand that various other modifications to the computer mouse 10 may be possible without affecting the operation of the computer mouse and that such modifications are contemplated as part of the invention. For instance, the Web switch 12 can be any electrical actuator known in the art, e.g., a button, a knob, a two-position switch, etc. Although it is preferred that the Web switch 12 be placed on the left side of the mouse 10, close to the thumb area of the right-handed user for easy access (and on the right side of the mouse 10 for devices designed for left-handed use), the Web switch 12 can be located in any area of the mouse 10. Moreover, the mouse 10 may be a wireless mouse, such that it communicates with the host computer 50 wirelessly, e.g., by transmitting and receiving infrared, optical or radio signals, or can be an optical mouse or other type of mouse which operates without a mouse ball.

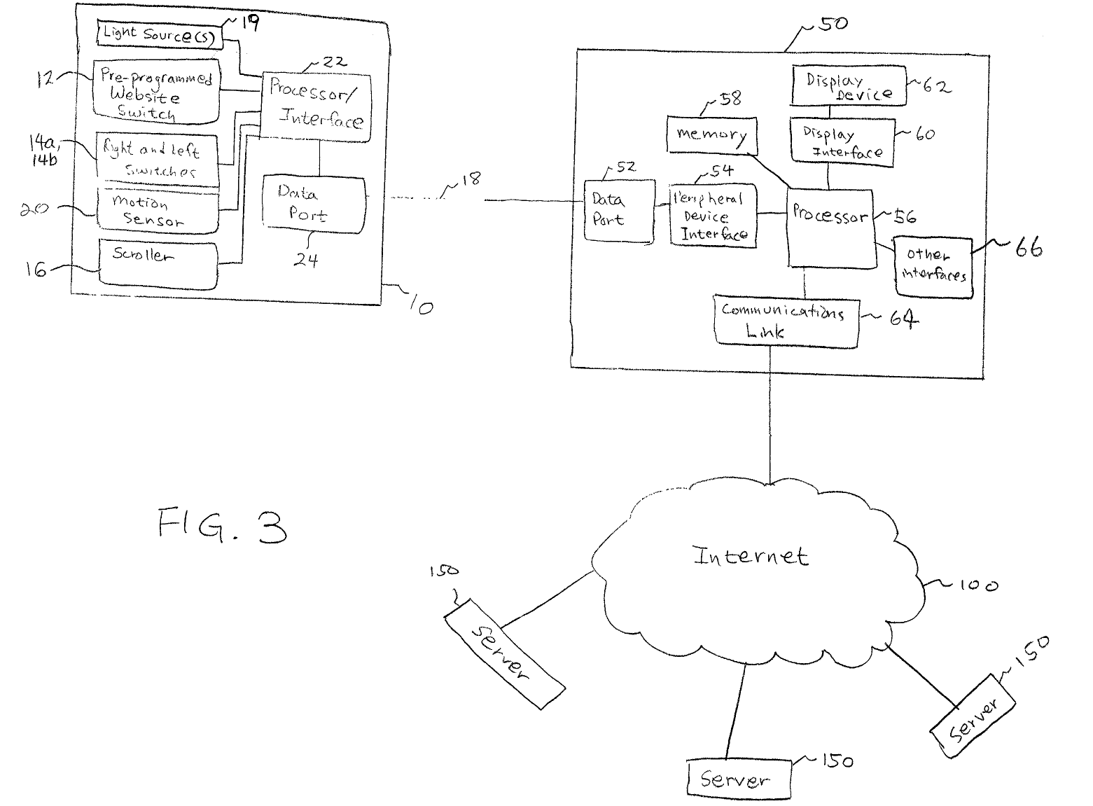

FIG. 3 shows a block diagram of the computer mouse 10 coupled to the host computer 50 in accordance with a preferred embodiment of the present invention. As shown in FIG. 3, the computer mouse 10 can be plugged into the host computer 50 or be coupled to it wirelessly. The host computer 50 is connected to a communications network, such as the Internet 100, extranets, intranets, etc. Through the Internet 100 or other network, the host computer 50 can access any of servers 150 on the Internet 100. The servers 150 can be maintained by e-merchants, ISPs, ASPs, or other sponsors of Websites.

The computer mouse 10 includes the pre-programmed Web switch 12, the right and left switches 14a and 14b, and the optional scroller 16 as discussed above. The computer mouse 10 further includes a light source or sources 19 for illuminating the Web switch 12 and/or the area 17, a motion sensor 20 associated with the mouse ball (if applicable), a processor/interface 22, and a data port 24, all operatively connected. The mouse 10 may further encompass any other components or circuitry typically found in a conventional mouse.

The motion sensor 20 detects a position of the mouse ball (if present) as is well known in the art. The processor/interface 22 may control illumination of the light source(s) 19 to indicate the operational status of the Web switch 12 and/or the data port 24. The light source(s) 19 may be powered through the host computer 50 or a power source which may be located in the mouse. The processor/interface 22 processes signals from the switches 12, 14a, 14b, the scroller 16, and the motion sensor 20, whereas the data port 24 transmits the processed signals from the processor/interface 22 to the host computer 50 through the connector 18 or wireless connection. The data port 24 and the processor/interface 22 may also receive and process signals from the host computer 50 as needed.

The predetermined Website data can be “pre-programmed” into the mouse 10 in a number of different ways. For instance, the predetermined Website data may be non-alterably stored in a memory accessible by the processor/interface 22. In another example, the Website data may be integrated into the circuitry of the mouse 10, e.g., in the processor/interface 22 or a circuit associated with the switch 12. Still in another example where the Website data represents a triggering signal, the “pre-programming” of the mouse 10 involves pre-programming the processor/interface 22 with the triggering signal such that the processor/interface 22 outputs the triggering signal to the host computer 50 in response to the actuation of the Web switch 12.

The host computer 50 may include a data port 52, a peripheral device interface 54, a processor 56, a memory 58 such as RAM or ROM, a display interface 60, a display device 62 such as a monitor, a communications link 64 for connecting to the Internet 100 or other networks, and additional peripheral device interfaces 66 (e.g., for a keyboard, a scanner, an optical pen, etc.), all operatively connected. Although not illustrated for the sake of clarity, the host computer 50 may include other components typically found in a computer, such as a keyboard, a CD driver, etc., and can be in any type of computer well known in the art, e.g., a desktop, a laptop, a workstation, etc.

The operation of the computer mouse 10 in connection with the host computer 50 according to one embodiment of the present invention is as follows. At an initial set-up, the user connects the computer mouse 10 having the pre-programmed Web switch(es) 12 to the user's host computer 50. In one embodiment, the user may be provided with computer software which must be installed in the host computer 50 to activate the pre-programmed Web switch 12 on the mouse 10 as discussed above. This software enables the host computer 50 to recognize and process the Website data stored in association with the Web switch 12. Without the installation of such software, the mouse 10 may merely function as a conventional mouse, i.e., without the benefit of the Web switch 12. In another embodiment, the computer mouse 10 itself may be installed with software which allows the host computer 50 to process the Website data from the mouse 10. This software pre-stored in the mouse 10 may also be uploaded automatically to the host computer 50 when the mouse 10 is set up initially and connected to the host computer 50, so that the user does not need to install separate software into the host computer.

After the initial set-up is completed, the user runs the Web browser installed on the host computer 50 and connects to a communications network such as the Internet 100 through the communications link 64. Once the host computer 50 is connected to the Internet 100, the user can actuate or press the pre-programmed Web switch 12 at any time. The actuation of the Web switch 12 causes the processor/interface 22 to transmit the pre-stored Website data (e.g., URL of the CPD Website of the merchant or a triggering signal) to the computer 50 through the data port 24.

The data port 52 of the host computer 50 receives the Website data which the peripheral device interface 54 converts into a form recognizable by the processor 56. The processor 56 receives the converted Website data and processes it according to the conventional methods of processing Website data. The processor 56 communicates the Website data to an appropriate server 150 on the Internet 100 using well-known HyperText Transport Protocols (HTTPs) or other established protocols.

The processor 56 receives from the server 150 the Web page data (e.g., HTML files) corresponding to the Website data and processes and displays it on the display device 62 through the display interface 60.

As mentioned above, once the host computer 50 is connected to the Internet 100, the user may actuate the Web switch 12 at any time thereafter to initiate the direct Website accessing process of the present invention. In the alternative, the software installed in the host computer 50 and/or the mouse 10 for operating the Web switch 12 as discussed above may link the dial-up functions of the Web browser to the operation of the Web switch 12, such that a single actuation of the Web switch 12 automatically commences the dial-up procedures for connecting to the Internet 100 and results in the display of the Web page of the predetermined Website(s) on the display device 62. Accordingly, by merely actuating the pre-programmed Web switch 12, the user can easily and conveniently access the designated Website.

In accordance with another embodiment, the concept of utilizing the pre-programmed Web switch(es) may be applied to other computer peripheral devices such as a keypad, a keyboard, a touch pad, a stylus, etc. In one exemplary embodiment, a keypad connected to the keyboard or mouse jack of the host computer may be provided. The keypad may include at least one pre-programmed Web switch for automatically accessing at least one predetermined Website (e.g., CPD Website of a merchant, or CPD Website and main Website of the merchant) according to the present invention. In addition, the keypad may include special keys or buttons which can assist the user in conducing online transactions once the user accesses the predetermined Website. For example, if the predetermined Website of “WWW.ETRADEcpd.com” is pre-programmed into the computer mouse, which is sponsored by E*Trade Securities, Inc., the keypad may include keys or buttons designated to execute commands such as “SELL”, “BUY”, “TRADE”, “OPTIMIZE PORTFOLIO”, etc., so that they can facilitate the online transaction processes. Different command keys or buttons may be provided for different computer peripheral devices depending on the application and the Website accessible by the peripheral devices.

In accordance with another embodiment of the present invention, the system may be configured so that the customer is directly connected to the main Website of the e-merchant without the redirecting process offered by the CPD Website of the merchant.

In accordance with other embodiments, the system can be configured such that the user can register their personal information at the CPD Website. Upon installation of the merchant-specific peripheral device of the present invention and/or actuating a pre-programmed switch on the device connected to the PC, the user may be able to enter user information (e.g., name, address, phone number, etc.) which may be subsequently transmitted to the CPD Website or any other designated registration site for registering user information. The merchant can use the registered user information to develop user-specific tracking data for tracking Web access by each user, and to provide more individualized and personal service to the users.

Thus, the present invention offers many advantages. For instance, Internet users can easily and conveniently access predetermined Websites using the computer peripheral devices of the present invention and in certain embodiments execute commands once such Websites have been accessed.

Moreover, the computer peripheral devices of the present invention may be utilized as advertising and market study tools through which the advertisers can gain competitive business edge into desired markets. The marketing agency provides to each merchant the merchant-specific computer peripheral devices wherein the Website data associated with the merchant is pre-programmed into the computer peripheral devices which are then distributed to potential or current customers, either for free or for a fee. Since each computer peripheral device includes an advertising area for displaying merchant-specific information, e.g., one or more of the merchant's logo, business name, Website address or other information associated with the merchant, it will function as a visible and constant reminder to the user as long as the computer peripheral device is located within the user's sight.

Even more effectively, the value of the computer peripheral device of the present invention increases significantly if the user actually uses the pre-programmed Web switch(es) on the computer peripheral device. Each time the user actuates the pre-programmed Web switch(es) on the computer peripheral device as discussed above, the CPD Website or another Website through the CPD Website will be displayed automatically on the user's monitor. The ease and convenience associated with operating a pre-programmed Web switch encourages the user to access more frequently the merchant's Website(s), and increases the visibility of the merchant and the likelihood of business transactions being conducted through that Website(s). Therefore, the computer peripheral devices of the present invention provide convenience to Internet users as well as competitive business advantages to merchants and Website sponsors, benefitting all parties involved in e-commerce.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A method of promoting a merchant, the method comprising the step of:
providing a plurality of merchant-specific computer peripheral devices to the merchant for distribution to users,
wherein each of the devices includes at least one pre-programmed switch for accessing automatically at least one predetermined site associated with the merchant on a communications network, and further includes merchant-specific information fixedly provided on each of the devices for viewing by a user, and
wherein the merchant-specific information is associated with the merchant and is not associated with a manufacturer of the devices.

2. The method of claim 1, wherein the predetermined site is a computer peripheral device (CPD) Website dedicated to users of the switches on the computer peripheral devices.

3. The method of claim 2, wherein the predetermined site further includes a second Website associated with the CPD Website, wherein an actuation of the switch by a user results in an automatic connection to the CPD Website which redirects automatically to the second Website.

4. The method of claim 3, wherein the CPD Website functions as an access tracking device, for tracking accessing of the second Website by the users of the computer peripheral devices.

5. The method of claim 2, wherein the computer peripheral devices are computer mice for use with computers of the users.

6. The method of claim 5, wherein the pre-programmed switch of each computer mouse comprises a button formed on a side of the mouse.

7. The method of claim 2, further comprising:
providing a plurality of merchant-specific computer program products to the merchant for distribution to the users, wherein each of the products is to be used with one of the devices of the merchant for selectively enabling an operation of the pre-programmed switch on said one of the devices.

8. The method of claim 7, wherein each of the computer peripheral devices is configured to transmit a pre-programmed signal to an associated computer when the pre-programmed switch on the computer peripheral device is actuated.

9. The method of claim 8, wherein the pre-programmed signal contains predetermined Web address information associated with the predetermined site.

10. The method of claim 8, wherein the pre-programmed signal is a triggering signal for triggering the computer to retrieve from its memory a predetermined Web address associated with the predetermined site.

11. The method of claim 7, wherein each of the computer peripheral devices is without alphanumeric keys.

12. The method of claim 1, wherein each of the computer peripheral devices is pre-loaded with a computer program product for configuring an associated computer to process a predetermined signal transmitted from the device when the pre-programmed switch on the computer peripheral device is actuated.

13. The method of claim 12, wherein the predetermined signal contains prestored Web address information associated with the predetermined site.

14. The method of claim 12, wherein the predetermined signal is a triggering signal for triggering the computer to retrieve from its memory a predetermined Web address associated with the predetermined site.

15. The method of claim 1, wherein the computer peripheral devices are selected from the group consisting of computer mice, computer keypads, touch pads and styluses.

16. A method of promoting a merchant, the method comprising the step of:
providing at least one merchant-specific computer peripheral device associated with a merchant to a user,
wherein the device includes at least one pre-programmed switch for accessing automatically at least one predetermined site associated with the merchant on a communications network, and merchant-specific information fixedly provided on the device for viewing by the user, and
wherein the merchant-specific information is associated with the merchant and is not associated with a manufacturer of the device.

17. The method of claim 16, wherein the predetermined site is a computer peripheral device (CPD) Website dedicated to users of switches on the computer peripheral devices.

18. The method of claim 17, wherein the predetermined site further includes a second Website associated with the CPD Website, wherein an actuation of the switch by the user results in an automatic connection to the CPD Website which redirects automatically to the second Website.

19. The method of claim 18, wherein the CPD Website functions as an access tracking device for tracking accessing of the second Website by the users of the computer peripheral devices.

20. The method of claim 17, wherein the computer peripheral device is a computer mouse for use with a computer of the user.

21. The method of claim 20, wherein the pre-programmed switch of the computer mouse comprises a button formed on a side of the mouse.

22. The method of claim 17, further comprising:
providing to the user a merchant-specific computer program product for use with the computer peripheral device,
wherein the product is capable of selectively enabling an operation of the pre-programmed switch on the computer peripheral device.

23. The method of claim 22, wherein the computer peripheral device is configured to transmit a pre-programmed signal to an associated computer when the pre-programmed switch on the computer peripheral device is actuated.

24. The method of claim 23, wherein the pre-programmed signal contains predetermined Web address information associated with the predetermined site.

25. The method of claim 23, wherein the pre-programmed signal is a triggering signal for triggering the computer to retrieve from its memory a predetermined Web address associated with the predetermined site.

26. The method of claim 23, wherein the computer peripheral device is without alphanumeric keys.

27. The method of claim 16, wherein the computer peripheral device is pre-loaded with a computer program product for configuring an associated computer to process a predetermined signal transmitted from the computer peripheral device when the pre-programmed switch on the computer peripheral device is actuated.

28. The method of claim 27, wherein the predetermined signal contains prestored Web address information associated with the predetermined site.

29. The method of claim 27, wherein the predetermined signal is a triggering signal for triggering the computer to retrieve from its memory a predetermined Web address associated with the predetermined site.

30. The method of claim 16, wherein the computer peripheral device is selected from the group consisting of a computer mouse, a computer keypad, and a stylus.

31. A merchant-specific computer peripheral device for promoting a merchant, the device comprising:
data pre-programmed in the device;
a switch for automatically accessing a predetermined site associated with the merchant by means of the data; and
an interface, coupled to the switch, for communicating the data to a computer,
wherein the device further includes means for fixedly displaying merchant-specific information for viewing by a user, and
wherein the merchant-specific information is associated with the predetermined site and is not associated with a manufacturer of the device.

32. The computer peripheral device of claim 31, wherein the data includes a Web address of the predetermined site, wherein the predetermined site is a computer peripheral device (CPD) Website dedicated to users of the switches on the computer peripheral devices.

33. The computer peripheral device of claim 32, wherein the predetermined site further includes a second Website associated with the CPD Website, wherein an actuation of the switch by a user results in an automatic connection to the CPD Website which redirects automatically to the second Website.

34. The computer peripheral device of claim 33, wherein the CPD Website functions as an access tracking device for tracking accessing of the main Website by the users of the switches on the computer peripheral devices.

35. The computer peripheral device of claim 33, wherein the data further includes information pertaining to the user.

36. The computer peripheral device of claim 31, wherein the data represents a triggering signal for triggering the computer to retrieve from its memory a predetermined Web address of the predetermined site.

37. The computer peripheral device of claim 36, wherein the predetermined site is a computer peripheral device (CPD) Website dedicated to users of the switches on the computer peripheral devices.

38. The computer peripheral device of claim 37, wherein the predetermined site further includes a second Website associated with the CPD Website, wherein an actuation of the switch by a user results in an automatic connection to the CPD Website which redirects automatically to the second Website.

39. The computer peripheral device of claim 38, wherein the CPD Website functions as an access tracking device for the merchant, for tracking accessing of the second Website by the users of the switches on the computer peripheral devices.

40. The computer peripheral device of claim 31, wherein the computer peripheral device is without alphanumeric keys.

41. The computer peripheral device of claim 31, wherein the computer peripheral device is a computer mouse.

42. The computer peripheral device of claim 31, wherein the computer peripheral device is a keypad.

43. The computer peripheral device of claim 42, wherein the keypad further includes:
at least one second switch, coupled to the interface and associated with second data pre-programmed in the computer peripheral device, the second data including specific command data for executing commands on the predetermined site of the merchant.

44. The computer peripheral device of claim 31, further comprising:
at least one light source, coupled to the switch, for visually indicating an operational status of the switch.

45. The computer peripheral device of claim 31, wherein the computer peripheral device includes a plurality of switches for automatically accessing predetermined sites on the communications network.

46. The computer peripheral device of claim 31, wherein the data is non-alterable.

47. The computer peripheral device of claim 46, wherein each of the computer peripheral devices is pre-loaded with a computer program product for configuring an associated computer to process a predetermined signal transmitted from the computer peripheral device when the pre-programmed switch on the computer peripheral device is actuated.

48. The method of claim 47, wherein the predetermined signal contains prestored Web address information associated with the predetermined site.

49. The method of claim 47, wherein the predetermined signal is a triggering signal for triggering the computer to retrieve from its memory a pre deter mined Web address associated with the predetermined site.

50. The method of claim 31, wherein an operation of the switch alone can be selectively enabled by a computer program product operating on the computer.

51. A computer program product embodied on computer readable media readable by a computer, the product comprising:
computer-readable program code means for configuring the computer to access automatically at least one predetermined site of a merchant in response to a predetermined signal, wherein the predetermined signal is transmitted to the computer from a merchant-specific computer peripheral device in response to an actuation of a switch on the device,
wherein the predetermined site is associated with the merchant and is not associated with a manufacturer of the computer program product.

52. The computer program product of claim 51, wherein the computer-readable means stores in the computer a predetermined Web address associated with the predetermined site of the merchant, such that the computer retrieves the stored Web address upon receipt of the predetermined signal.

53. The computer program product of claim 52, further comprising:
computer-readable program code means for selectively enabling an operation of the switch on the device.

54. The computer program product of claim 51, wherein the predetermined site is a computer peripheral device (CPD) Website dedicated to users of the switches on the computer peripheral devices.

55. The computer program product of claim 54, wherein the predetermined site further includes a second Website associated with the CPD Website, wherein an actuation of the switch by a user results in an automatic connection to the CPD Website which redirects automatically to the second Website.

56. The computer program product of claim 55, wherein the CPD Website functions as an access tracking device for the merchant, for tracking accessing of the main Website by the users of the switches on the computer peripheral devices.
